(19) United States
(12) Patent Application Publication
(10) Pub. No.: US 2026/0196078 A1
(43) Pub. Date: Jul. 9, 2026

(54) MULTI-MODAL BEHAVIORAL FINGERPRINT AND INPUT-MOTION CORRELATION FOR DETECTING PROXY TEST TAKING IN ONLINE EXAMINATIONS

(71) Applicants: Constructor Technology AG, Schaffhausen (CH); Constructor Education and Research Genossenschaft, Schaffhausen (CH)

(72) Inventors: Rasilia Rakhmatulina, Sofia (BG); Andrey Adashchik, Sofia (BG); Sergey Ulasen, Singapore (SG); Serg Bell, Singapore (SG); Stanislav Protasov, Singapore (SG); Nikolay Dobrovolskiy, Alanya (TR); Laurent Dedenis, Geneve (CH)

(21) Appl. No.: 19/555,040

(22) Filed: Mar. 3, 2026

Related U.S. Application Data
(63) Continuation-in-part of application No. 19/034,694, filed on Jan. 23, 2025.
(63) Continuation-in-part of application No. 19/004,064, filed on Dec. 27, 2024, now Pat. No. 12,531,002.

(51) Int. Cl. G06V 40/20; G06V 10/62; G06V 10/74; G06V 10/98; G06V 20/40; G06V 20/52; G06V 40/18; G06V 40/40; G09B 7/00

(52) U.S. Cl. CPC G06V 40/20; G06V 10/62; G06V 10/761; G06V 10/993; G06V 20/46; G06V 20/52; G06V 40/18; G06V 40/45; G09B 7/00

(57) ABSTRACT

Aspects of the present disclosure include a method for verifying live user presence in an

online session, comprising obtaining at least one video stream of a user captured during at least one previous presentation of at least one user interface (UI) on a display, obtaining input events representing previous user interactions with the UI, generating a behavioral digital fingerprint profile based on the video stream and the input events, initiating an online exam during the online session by providing, for presentation on the display, at least one additional UI, receiving at least one additional video stream of the user during the exam, receiving additional input events representing user interactions with the additional UI, determining exam-specific behavioral features based on the additional video stream and the additional input events, and verifying whether the user is taking the exam based on at least one of the features or the profile.

### CROSS-REFERENCE TO RELATED APPLICATIONS

This application is a continuation-in-part of and claims the benefit of priority to both U.S. patent application Ser. No. 19/034,694, filed on Jan. 23, 2025 and entitled “PROCTORING OF ONLINE EXAMINATIONS USING GAZE DETERMINATION,” and U.S. patent application Ser. No. 19/004,064, filed on Dec. 27, 2024 and entitled “SYSTEMS AND METHODS FOR DETECTION OF THE PRESENCE OF A PERSON IN FRONT OF A DISPLAY WITH A CAMERA,” the contents of which are incorporated by reference herein in the entirety.

### FIELD OF TECHNOLOGY

The present disclosure relates to the field of online presence and liveness verification, and, more specifically, to systems and methods for detecting proxy text taking in online examinations using multi-modal behavioral fingerprint and input-motion correlation.

### BACKGROUND

A deepfake is an artificial image or video.

Examinations are now commonly taken on computers, offering convenience and accessibility for both learners and institutions. These computer examinations are conducted through specialized software or platforms that allow learners to take tests from remote locations. They often include features like automated proctoring, time tracking, and instant grading. However, this shift to computer examinations has also introduced new opportunities for cheating. Learners might use unauthorized resources such as notes, search engines, or communication tools like messaging apps during the exam. Other learners may simply have someone else pretend to be the learner and take the computer examination for the learner under the learner's login credentials. In other cases, in examinations with video proctoring, a pre-recorded video loop or a deepfake of the candidate sitting still or pretending to take the exam could be played while the real exam is being taken by someone else. These methods exploit the weaknesses in online proctoring systems, especially in cases where human proctors or artificial intelligence (AI) may not be able to detect subtle signs of cheating. Therefore, there is a need to strengthen online presence and liveness verification during online sessions (e.g., remote exams or remote proctoring) against deepfakes, prerecorded video, and remote helpers.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

One aspect of the present disclosure includes a method for verifying live user presence in an online session. The method comprises obtaining at least one video data stream of a user captured during at least one previous presentation of at least one user interface on a display, and obtaining at least one set of input events captured via one or more input devices and representing previous user interactions with the at least one user interface during the at least one previous presentation. The method further comprises generating a behavioral digital fingerprint profile corresponding to the user based on the at least one video data stream and the at least one set of input events, and initiating an online exam during the online session by providing, for presentation on the display, at least one additional user interface. The method further comprises receiving at least one additional video data stream of the user during the online exam, and receiving at least one additional set of input events captured via the one or more input devices and representing user interactions with the at least one additional user interface during the online exam. The method further comprises determining one or more behavioral features specific to the online exam based on the at least one additional video data stream and the at least one additional set of input events, and verifying whether the user is taking the online exam based on at least one of the one or more behavioral features or the behavioral digital fingerprint profile.

Another aspect of the present disclosure includes a system for verifying live user presence in an online session. The system comprises one or more memories configured to store executable instructions, and one or more processors communicatively coupled with the one or more memories. The one or more processors are configured, individually or in any combination, to execute the executable instructions to obtain at least one video data stream of a user captured during at least one previous presentation of at least one user interface on a display, and obtain at least one set of input events captured via one or more input devices and representing previous user interactions with the at least one user interface during the at least one previous presentation. The one or more processors are configured, individually or in any combination, to further execute the executable instructions to generate a behavioral digital fingerprint profile corresponding to the user based on the at least one video data stream and the at least one set of input events, and initiate an online exam during the online session by providing, for presentation on the display, at least one additional user interface. The one or more processors are configured, individually or in any combination, to further execute the executable instructions to receive at least one additional video data stream of the user during the online exam, and receive at least one additional set of input events captured via the one or more input devices and representing user interactions with the at least one additional user interface during the online exam. The one or more processors are configured, individually or in any combination, to further execute the executable instructions to determine one or more behavioral features specific to the online exam based on the at least one additional video data stream and the at least one additional set of input events, and verify whether the user is taking the online exam based on at least one of the one or more behavioral features or the behavioral digital fingerprint profile.

Another aspect of the present disclosure includes a non-transitory computer-readable medium having instructions for verifying live user presence in an online session. The instructions are executable by one or more processors, individually or in combination, to obtain at least one video data stream of a user captured during at least one previous presentation of at least one user interface on a display, and obtain at least one set of input events captured via one or more input devices and representing previous user interactions with the at least one user interface during the at least one previous presentation. The instructions are further executable by the one or more processors, individually or in combination, to generate a behavioral digital fingerprint profile corresponding to the user based on the at least one video data stream and the at least one set of input events, and initiate an online exam during the online session by providing, for presentation on the display, at least one additional user interface. The instructions are further executable by the one or more processors, individually or in combination, to receive at least one additional video data stream of the user during the online exam, and receive at least one additional set of input events captured via the one or more input devices and representing user interactions with the at least one additional user interface during the online exam. The instructions are further executable by the one or more processors, individually or in combination, to determine one or more behavioral features specific to the online exam based on the at least one additional video data stream and the at least one additional set of input events, and verify whether the user is taking the online exam based on at least one of the one or more behavioral features or the behavioral digital fingerprint profile.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram of an example environment for verifying live user presence in an online session, according to some aspects of the present disclosure;

FIG. 2 is a block diagram of an example enrollment module, according to some aspects of the present disclosure;

FIG. 3 is a block diagram of an example behavioral digital fingerprint creation module, according to some aspects of the present disclosure;

FIG. 4 is a block diagram of example monitoring module, according to some aspects of the present disclosure;

FIG. 5 is a block diagram of an example proxy detection module, according to some aspects of the present disclosure;

FIG. 6A is a first example pre-defined task performed as part of enrollment during an online session, according to some aspects of the present disclosure;

FIG. 6B is a second example pre-defined task performed as part of enrollment during an online session after the calibration, according to some aspects of the present disclosure;

FIG. 6C is a third example pre-defined task performed as part of enrollment during an online session, according to some aspects of the present disclosure;

FIG. 6D is a fourth example pre-defined task performed as part of enrollment during an online session, according to some aspects of the present disclosure;

FIG. 6E is an example monitoring during an online session after enrollment, according to some aspects of the present disclosure;

FIG. 7 is flow diagram of an example method for verifying live user presence in an online session, according to some aspects of the present disclosure; and

FIG. 8 presents an example of a general-purpose computer system on which aspects of the present disclosure can be implemented.

### DETAILED DESCRIPTION

Aspects of the disclosure improve online presence and liveness verification during online sessions (e.g., remote exams or remote proctoring) against deepfakes, prerecorded video, and remote helpers. Aspects of the disclosure determine whether a person visible to a camera during an online examination (i.e., online exam or remote exam) is the same person who is physically operating one or more local input devices to interact with an examination interface displayed during the online examination. In some aspects of the disclosure, before an examinee attends to or interacts with an online examination during a current online session, a behavioral digital fingerprint is created and stored for the examinee by: (1) recording the examinee's input events, such as keystroke dynamics and mouse behavior, prior to a start of the online examination, and (2) based on visible physical movements and/or an eye gaze of the examinee in a video captured prior to the start of the online examination, temporal and/or spatial relationships between the input events and the physical movements and/or the eye gaze are determined. For example, the behavioral digital fingerprint can be created based on the examinee's input events recorded and at least one video data stream captured during an enrollment of the examinee that occurred before the start of the online examination. As another example, the behavioral digital fingerprint can be created based on the examinee's historical input events recorded and at least one historical video data stream captured during one or more previous online sessions (e.g., previous online examinations) that occurred before the start of the online examination. As another example, the behavioral digital fingerprint can be created based on a combination of the examinee's input events recorded and at least one video data stream captured during the enrollment and the examinee's historical input events recorded and at least one historical video data stream captured during the one or more previous online sessions. During the online examination itself, the online examination is monitored, such that new input events and new video of a person captured by a camera during the online examination are logged, correlations between current input events and visible physical movements and/or eye gaze captured in the new video are computed, and a resulting current behavioral pattern specific to the online examination is determined. The current behavioral pattern is then compared to the stored behavioral digital fingerprint. The online examination is flagged as potentially suspicious if at least one of the following occurs: (1) some of the new input events repeatedly occur without temporally associated physical movements of the person in the new video, or (2) a difference between the current behavioral pattern and the stored behavioral digital fingerprint exceeds a pre-defined threshold. For example, the online examination can be flagged as a potential cheating attempt in which the person is a deepfake or a prerecorded video, and another person (e.g., a remote helper or a proxy operator) is operating the local input devices to respond to on-screen examination content presented during the online examination. By providing a robust, hard to spoof liveness and user identity check during online sessions, aspects of the disclosure can improve identity verification during online sessions and increase the reliability of online exam proctoring and other similar online sessions.

Exemplary aspects are described herein in the context of a system, a method, and a non-transitory computer-readable medium for verifying live user presence in an online session. Aspects of the present disclosure obtaining at least one video data stream of a user captured during at least one previous presentation of at least one user interface on a display, obtaining at least one set of input events captured via one or more input devices and representing previous user interactions with the at least one user interface during the at least one previous presentation, generating a behavioral digital fingerprint profile corresponding to the user based on the at least one video data stream and the at least one set of input events, initiating an online exam (i.e., online examination) during the online session by providing, for presentation on the display, at least one additional user interface, receiving at least one additional video data stream of the user during the online exam, receiving at least one additional set of input events captured via the one or more input devices and representing user interactions with the at least one additional user interface during the online exam, determining one or more behavioral features specific to the online exam based on the at least one additional video data stream and the at least one additional set of input events, and verifying whether the user is taking the online exam based on at least one of the one or more behavioral features or the behavioral digital fingerprint profile.

In one aspect, the at least one previous presentation occurred prior to the online exam, and the at least one previous presentation comprises at least one of an enrollment, a previous online exam different from the online exam during the online session, or a previous online session different from the online session.

In one aspect, the behavioral digital fingerprint profile is stored, where the stored behavioral digital fingerprint profile is mapped to an identifier corresponding to the user.

In one aspect, each input event has a corresponding timestamp.

In one aspect, based on one or more video frames of the at least one video data stream, at least one body region of the user corresponding to a physical action of the user is detected, and a movement (i.e., physical movement) of the at least one body region is tracked during the at least one previous presentation. The behavioral digital fingerprint profile characterizes timing of the at least one set of input events and at least one of spatial correspondences or temporal alignments between the at least one set of input events and the tracked movement of the at least one body region.

In one aspect, the one or more input devices comprise a keyboard, and the timing of the at least one set of input events comprises at least one a key hold time of a key of the keyboard, an inter-key interval between two or more keys of the keyboard, a distribution of burst lengths of consecutive key presses of the two or more keys, or a rate of error corrections.

In one aspect, based on the one or more video frames of the at least one video data stream, a gaze direction of the user during the at least one previous presentation and a region of the display the gaze direction is directed to is estimated. The behavioral digital fingerprint profile further characterizes at least one of spatial correspondences or temporal alignments between the at least one set of input events and at least one of the gaze direction or the region of the display.

In one aspect, the determining the one or more behavioral features comprises detecting, based on one or more video frames of the at least one additional video data stream, at least one body region of the user corresponding to a physical action of the user, tracking a movement (i.e., physical movement) of the at least one body region during the exam, and, for each subset of the at least one additional set of input events, determining one or more corresponding correlation measurements indicative of at least one of spatial correspondences or temporal alignments between the subset and the tracked movement of the at least one body region.

In one aspect, the determining the one or more behavioral features further comprises estimating, based on the one or more video frames of the at least one additional video data stream, a gaze direction of the user during the exam and a region of the display the gaze direction is directed to, and, for each subset of the at least one additional set of input events, determining one or more corresponding correlation measurements indicative of at least one of spatial correspondences or temporal alignments between the subset and at least one of the gaze direction or the region of the display.

In one aspect, the verifying whether the user is taking the exam comprises determining a similarity measurement indicative of a degree of similarity between the one or more behavioral features and the behavioral digital fingerprint profile, verifying the user is taking the exam in response to determining the similarity measurement does not exceed a pre-defined similarity threshold and, for each subset of the at least one additional set of input events, one or more corresponding correlation measurements does not exceed a corresponding pre-defined correlation threshold, and verifying the user is not taking the exam in response to determining the similarity measurement exceeds the pre-defined similarity threshold or for at least one subset of the at least one additional set of input events, one or more corresponding correlation measurements exceeds a corresponding pre-defined correlation threshold.

In one aspect, at least one action is triggered in response to verifying the user is not taking the exam, where the at least one action comprises at least one of pausing the exam, terminating the exam, transmitting an alert to a proctor, or recording there is no spatial correspondence or temporal alignment between a subset of the at least one additional set of input events and at least one of the tracked movement of the at least one body region, the gaze direction, or the region of display.

In one aspect, the at least one video data stream and the at least one additional video data stream are captured via at least one camera.

In one aspect, confidence score associated with the verifying is estimated based one or more conditions, where the one or more conditions include at least one of amount of lighting in the at least one additional video data stream, amount of contrast in the at least one additional video data stream, amount of body occlusion in the at least one additional video data stream, or video quality of the at least one additional video data stream.

In one aspect, the verifying whether the user is taking the exam comprises determining

whether there is a correlation between the at least one additional set of input events and at least one of a physical movement or an eye gaze direction detected in the at least one additional video data stream.

In one aspect, the verifying whether the user is taking the exam comprises identifying the user based on one or more patterns linking the at least one additional set of input events to at least one of a physical movement or an eye gaze direction detected in the at least one additional video data stream.

Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

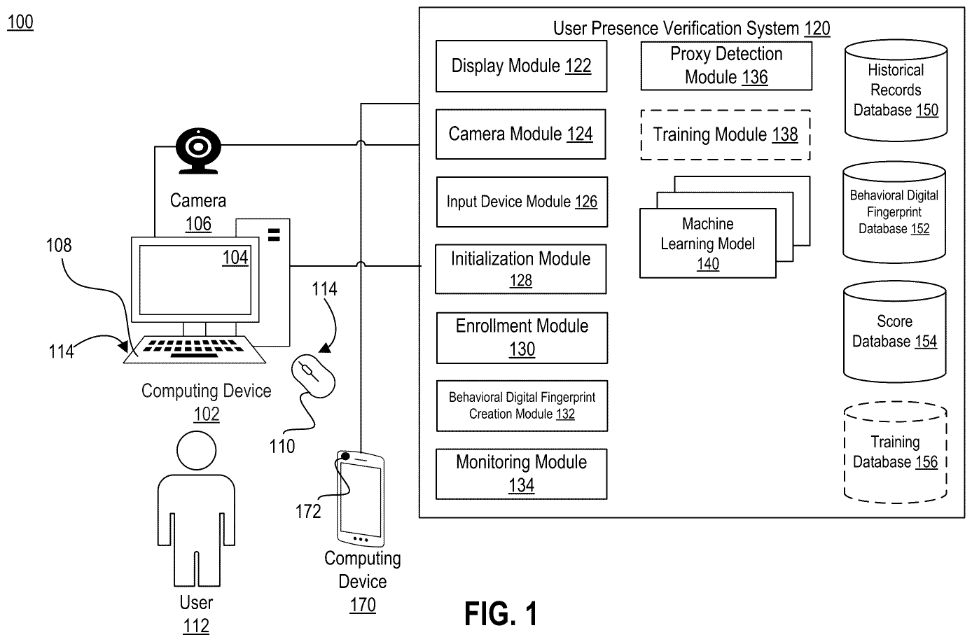

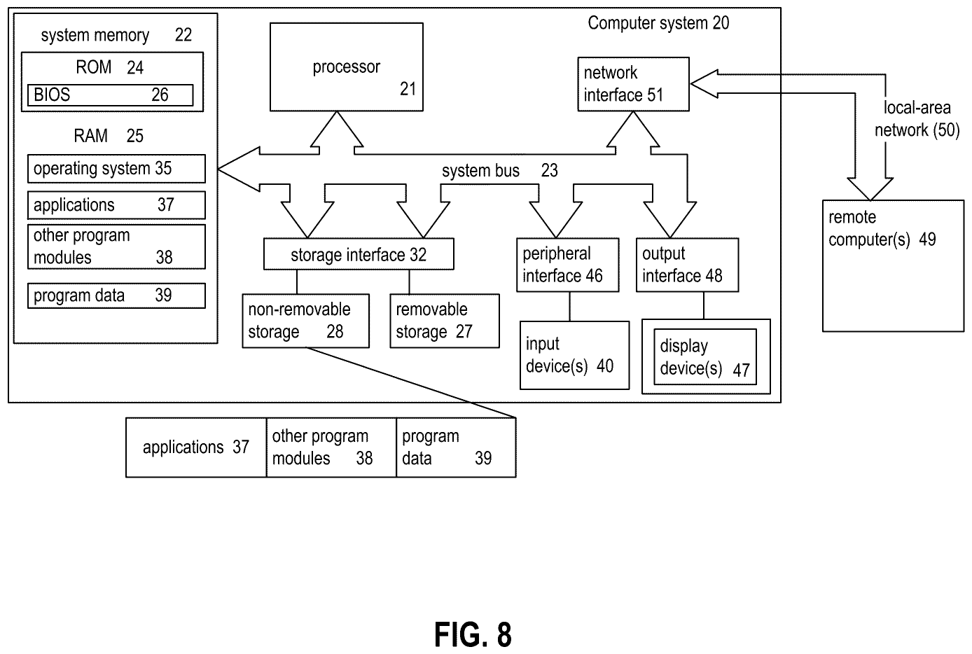

FIG. 1 is a block diagram of an example environment 100 for verifying live user presence in an online session, according to some aspects of the present disclosure. In some aspects, the environment 100 includes a computing device 102. In some aspects, the computing device 102 in FIG. 1 is implemented as a computer system 20 in FIG. 8. Examples of a computing device 102 include, but are not limited to, a mobile phone, a smart phone, a laptop, a tablet computer, a personal digital assistant, a wearable device (e.g., a smart watch, a head-mounted display, smart glasses, etc.), a desktop computer, a gaming console, an Internet of Things (IoT) device, and/or other computerized devices.

In some aspects, the environment 100 includes a display 104 for displaying on-screen content. The display 104 is coupled to, or integrated in, the computing device 102. In one non-limiting example aspect, the display 104 is positioned in front of a user 112.

In some aspects, the environment 100 includes one or more input devices 114 that the user 112 can utilize to provide user input. Examples of an input device 114 include, but are not limited to, a keyboard 108, a mouse 110 and/or another pointing device (e.g., a trackpad, a stylus, etc.), a number pad, a touch-sensitive display, a navigation key, a function key, a microphone, a voice recognition component, or any other mechanism capable of receiving an input from the user 112, or any combination thereof. In one aspect, an input device 114 is coupled to, or integrated in, the computing device 102. In some aspects, an input device 114 and the computing device 102 can exchange data (e.g., input events) over a wired and/or wireless communication link (e.g., a wireless connection such as a Wi-Fi connection or a cellular data connection, a wired connection, or a combination of the two).

In some aspects, the computing device 102 executes a user presence verification system 120, which may be a standalone online presence and liveness verification software or a software component providing one or more online presence and liveness verification tools. The computing device 102 allows a user 112 to participate in an online session administered and/or proctored by the user presence verification system 120. As described in detail later herein, the user presence verification system 120 leverages advanced computer vision and/or machine learning techniques to create a behavioral digital fingerprint corresponding to an online session enrollee (e.g., the user 112) before the online session is initiated, determine a current behavioral pattern of a person in video (e.g., captured by camera 106) during the online session based on input events (e.g., from one or more input devices 114) and visible physical movements and/or an eye gaze detected in the video, and compare the current behavioral pattern against the behavioral digital fingerprint corresponding to the enrollee to verify live presence of the enrollee during the online session (i.e., the person in the video is the enrollee).

In some aspects, the environment 100 includes a camera 106 for capturing a video data stream. In one aspect, the camera 106 is coupled to, or integrated in, the computing device 102. In another aspect, the camera 106 is coupled to the user presence verification system 120. The user presence verification system 120 can obtain one or more video data streams captured via the camera 106. In one non-limiting example aspect, the camera 106 is positioned in front of the user 112 and captures a video data stream of the user 112 during an online session administered and/or proctored by the user presence verification system 120.

In some aspects, the environment 100 includes a second camera 172 for capturing a video data stream. In one aspect, the second camera 172 is coupled to, or integrated in, the computing device 102. In another aspect, the second camera 172 is coupled to, or integrated in, a different computing device 170 (e.g., a smart phone). In another aspect, the second camera 172 is coupled to the user presence verification system 120. The user presence verification system 120 can obtain one or more video data streams captured via the second camera 172. In one non-limiting example aspect, the first camera 106 and the second camera 172 are positioned at different positions relative to the user 112 (e.g., the first camera 106 is positioned in front of the user 112, and the second camera 172 is positioned to a side of the user 112), such that the cameras 106 and 172 capture video data streams of the user 112 from different perspectives (i.e., the different positions) during an online session administered and/or proctored by the user presence verification system 120. In some aspects, the first camera 106 and the second camera 172 are designated as a main camera and a secondary camera, respectively.

In some aspects, the user presence verification system 120 includes a plurality of modules. In some aspects, the computing device 102 can execute at least one of the plurality of modules. In some aspects, the user presence verification system 120 can be implemented in the computing device 102 or a cloud network (not shown) that is configured to execute the plurality of modules that together make up the user presence verification system 120.

In some aspects, the user presence verification system 120 includes a display module 122 configured to generate one or more graphical user interfaces (GUIs), where each GUI includes content for presentation on the display 104 during an online session administered and/or proctored by the user presence verification system 120.

In some aspects, the user presence verification system 120 includes a camera module 124 configured for video acquisition. Specifically, during an enrollment for an online session to be administered and/or proctored by the user presence verification system 120, the camera module 124 is configured to activate/trigger the camera 106 and/or the camera 172 to capture continuous video data stream(s) during the online session, and obtain the video data stream(s).

In some aspects, the user presence verification system 120 includes an input device module 126 configured for input events acquisition. Specifically, for each input device 114 (e.g., keyboard 108, mouse 110 and/or another pointing device, etc.), the input device module 126 is configured to receive one or more input events from the input device 114. Each input event comprises a user input provided by the user 112 via an input device 114.

In some aspects, the user presence verification system 120 includes an initialization module 128 configured to initialize an online session with the user 112. In some aspects, an online session comprises at least one of the following: (1) an enrollment, or (2) an online examination (i.e., online exam or remote exam) or other similar session (e.g., an online course/program, such as an online training course/program, online certification course/program, online tutorial, etc.) administered and/or proctored by the user presence verification system 120. In some aspects, an enrollment always occurs prior to the start of an online examination or other similar session.

In some aspects, the initialization module 128 is configured to invoke the camera module 124 which in turn activates/triggers the camera 106 and/or the camera 172 to capture continuous video data stream(s) during the online session. In one aspect, the camera 106 and/or the camera 172 are activated/triggered after the online session is initialized.

In some aspects, the initialization module 128 is configured to monitor the progress (i.e., state/status) of the online session. In some aspects, a state/status of the online session is indicative of a progression of the online session (e.g., question index, current GUI presented on the display 104, etc.) and/or whether the online session is potentially suspicious (e.g., whether there is a potential cheating attempt) (e.g., cheating score or trust score).

In some aspects, the user presence verification system 120 includes an enrollment module 130 configured to initiate an enrollment during which the user 112 is enrolled for an online examination (or other similar session) to be administered and/or proctored by the user presence verification system 120 at a later time (e.g., after the enrollment). In some aspects, the enrollment module 130 initiates the enrollment by invoking the display module 122 to present a GUI representing an enrollment interface on the display 104. In one aspect, the enrollment occurs at the start of the online session or prior to the start of the online examination (or other similar session). In one aspect, the enrollment is associated with a user identity of the user 112 (e.g., personal identification information (PII), such as identification number, name, etc.).

In some aspects, as part of the enrollment, the enrollment module 130 is configured to present an instruction to the user 112, where the instruction prompts the user 112 to perform one or more pre-defined tasks. In some aspects, the enrollment interface and the instruction are presented simultaneously. In one aspect, the enrollment module 130 invokes the display module 122 to present the instruction on the display 104 (e.g., as part of the enrollment interface). In another aspect, the enrollment module 130 invokes another module (not shown) of the user presence verification system 120 to activate/trigger audio playback of the instruction, i.e., the instruction is presented via one or more audio speakers (not shown).

Examples of a pre-defined task the user 112 can be instructed to perform include, but are not limited to, typing a sample text (e.g., typing into a text box or another text input field of the enrollment interface), filling out a digital form (e.g., typing into one or more text input fields and/or selecting one or more buttons of the enrollment interface), clicking or selecting one or more specified user interface elements (e.g., clicking or selecting one or more buttons and/or one or more other user interface elements of the enrollment interface), or scrolling through content (e.g., scrolling through content of the enrollment interface).

In some aspects, the enrollment module 130 is configured to receive, as input, one or more input events from an input device group during the enrollment, where the input device group comprises at least one input device 114 utilized by the user 112 during the enrollment. The one or more input events received represent a user response from the user 112 to the instruction presented.

In some aspects, during the duration of the enrollment, the enrollment module 130 is configured to log (i.e., record) each input event received with corresponding input event information, resulting in a logged enrollment input event. A logged enrollment input event includes an input event received and at least one of the following corresponding input event information: a corresponding device identifier indicative of a particular input device 114 the input event is from; a corresponding event type indicative of an input type of the input event (e.g., keyboard activity such as key presses, mouse activity such as mouse clicks, other pointer activity, etc.); or a corresponding timestamp indicative of when the input event occurred.

In some aspects, the enrollment module 130 is configured to provide to one or more others modules of the user presence verification system 120 at least one of the following outputs: one or more logged enrollment input events, or enrollment interface information corresponding to the enrollment interface presented to the user 112 during the enrollment. In some aspects, the enrollment interface information indicates, for each user interface (UI) element (e.g., button, text area, etc.) of the enrollment interface, a corresponding screen position (e.g., screen coordinates) or screen region (i.e., screen layout) on the display 104 that the UI element is positioned at, and a corresponding identification for the UI element.

In some aspects, the user presence verification system 120 is configured to store the input events recorded (i.e., logged enrollment input events) of the user 112 and video data stream(s) captured by the camera 106 or the camera 172 during the online session (e.g., from camera module 124) in a database 150 (e.g., historical records database).

In some aspects, the user presence verification system 120 includes a behavioral digital fingerprint creation module 132 configured to receive at least one of the following inputs: video data stream(s) captured by the camera 106 and/or the camera 172 during the online session (e.g., from camera module 124); one or more logged enrollment input events (e.g., from enrollment module 130); or enrollment interface information corresponding to an enrollment interface presented to the user 112 during enrollment (e.g., from enrollment module 130).

In some aspects, the behavioral digital fingerprint creation module 132 performs, during the duration of the enrollment, an analysis for either each logged enrollment input event or each group of logged enrollment input events. In one aspect, a group of logged enrollment input events comprises consecutive logged enrollment input events occurring within a pre-defined short time interval during the enrollment (e.g., all key presses within a short time interval). In another aspect, a group of logged enrollment input events comprises all logged enrollment input events associated with a particular interactable UI element of the enrollment interface (e.g., clicking a particular button). Specifically, for each logged enrollment input event or each group of logged enrollment input events, the module 132 is configured to: (1) determine a corresponding time interval during which the logged enrollment input event(s) occur, (2) extract or select one or more corresponding video frames from the video data stream(s), where the one or more corresponding video frames are within a time window occurring before the corresponding time interval (i.e., pre-event window), (3) extract or select one or more additional corresponding video frames from the video data stream(s), where the one or more additional corresponding video frames are within a time window occurring around or spanning the corresponding time interval (i.e., post-event window), (4) utilize at least one machine learning model 140 to detect at least one corresponding physical movement (i.e., motion) of at least one body region (e.g., shoulders, arms, hands, head, etc.) of the user 112 during the enrollment, based on each corresponding video frame extracted or selected, and (5) optionally, utilize at least one machine learning model 140 to determine a corresponding eye gaze direction of the user 112 during the enrollment and a corresponding screen region on the display 104 that the eye gaze direction is towards, based on each corresponding video frame extracted or selected.

In some aspects, the behavioral digital fingerprint creation module 132 is configured to determine one or more input-dynamics features corresponding to one or more logged enrollment input events. For example, if the one or more logged enrollment input events comprise key presses (i.e., keyboard activity), the module 132 is configured to determine at least one of the following corresponding input-dynamics features: one or more hold times, where each hold time indicates an amount of time a particular key is held/pressed; one or more inter-key intervals, where each inter-key interval indicates an amount of time between holding/pressing consecutive keys; one or more error and correction statistics (e.g., correcting mistypes); or one or more distributions of burst lengths, where each burst length indicates a length of a burst of keyboard activity.

As another example, if the one or more logged enrollment input events comprise mouse clicks (i.e., mouse activity) or another type of pointer activity, the behavioral digital fingerprint creation module 132 is configured to determine at least one of the following corresponding input-dynamics features: one or more movement speeds (e.g., of mouse 110 or another pointing device); one or more acceleration patterns (e.g., of mouse 110 or another pointing device); one or more path curvatures (e.g., of mouse 110 or another pointing device); or one or more click timings (e.g., of mouse 110 or another pointing device).

In some aspects, the behavioral digital fingerprint creation module 132 is configured to temporally and/or spatially align one or more logged enrollment input events with at least one of a physical movement or an eye gaze direction of the user 112 during the enrollment, and determine one or more input-motion relationship features corresponding to the one or more logged enrollment input events. Examples of input-motion relationship features include, but are not limited to, the following: at least one statistic of motion magnitude for a detected physical movement (i.e., motion) in a body region of the user 112 during a temporal window surrounding at least one burst of keyboard, mouse, and/or pointer activity; a distribution of latency between onset of a detected physical movement (i.e., motion) and onset of at least one burst of keyboard, mouse, and/or pointer activity; or a frequency with which an eye gaze direction of the user 112 is towards a screen region of the display 104 that is associated with an active input target (e.g., an UI element of the enrollment interface) when a logged enrollment input event occurs.

In some aspects, the behavioral digital fingerprint creation module 132 is configured to aggregate one or more input-dynamics features and one or more input-motion relationship features corresponding to one or more logged enrollment input events into a behavioral digital fingerprint profile corresponding to the user 112. The behavioral digital fingerprint profile captures both dynamics of user inputs provided by the user 112 and temporal and/or spatial correspondences between the user inputs and at least one of visible physical movements and/or an eye gaze direction of the user 112 during the enrollment.

In some aspects, the behavioral digital fingerprint creation module 132 is configured to create a behavioral digital fingerprint corresponding to the user 112 based on one or more historical records corresponding to the user 112, where the one or more historical records include at least one historical input event recorded of the user 112 and at least one historical video data stream captured during one or more previous online sessions (e.g., previous online examinations) that the user 112 participated in and/or attended to and that occurred before the start of an online examination of the current online session. In one aspect, the behavioral digital fingerprint creation module 132 can obtain the one or more historical records corresponding to the user 112 from the historical records database 150. As another example, the behavioral digital fingerprint creation module 132 is configured to create a behavioral digital fingerprint corresponding to the user 112 based on a combination of at least one input event recorded of the user 112 and at least one video data stream captured during the enrollment and the one or more historical records corresponding to the user 112.

In some aspects, the behavioral digital fingerprint creation module 132 is configured to store a behavioral digital fingerprint profile corresponding to the user 112 in a database 152 (e.g., behavioral digital fingerprint database). In some aspects, the behavioral digital fingerprint profile is stored in association with a user identity of the user 112 (e.g., PII, such as identification number, name, etc.).

In some aspects, the user presence verification system 120 includes a monitoring module 134 configured to receive at least one of the following inputs: a behavioral digital fingerprint profile corresponding to the user 112 (e.g., from behavioral digital fingerprint creation module 132 or database 152); real-time video data stream(s) captured by the camera 106 and/or the camera 172 (e.g., from camera module 124) during the online session; one or more real-time input events from the same input device group utilized during enrollment (i.e., same input device(s) 114 utilized by the user 112 during the enrollment); or one or more real-time screen events indicating which UI elements and/or regions of current on-screen content (i.e., current GUI, such as a current online examination interface if the online session comprises an online examination) presented on the display 104 are active (e.g., focused user input field, currently visible page, etc.) (e.g., from display module 122).

In some aspects, the monitoring module 134 is configured to initiate an online examination (or other similar session) after enrollment of the user 112, where the online examination is associated with a user identity of the user 112 (e.g., PII, such as identification number, name, etc.). The monitoring module 134 is configured to invoke the display module 122 to present a GUI including current on-screen content 652 (e.g., a current online examination interface if the online session comprises an online examination) on the display 104. In some aspects, the monitoring module 134 is configured to obtain a behavioral digital fingerprint profile corresponding to the user 112 (e.g., from behavioral digital fingerprint creation module 132 or database 152).

In some aspects, during the duration of the online examination (or other similar session), the monitoring module 134 is configured to log (i.e., record) each real-time input event received with corresponding input event information, resulting in a logged real-time input event. A logged real-time input event comprises a real-time input event received and at least one of the following corresponding input event information: a corresponding device identifier indicative of a particular input device 114 the real-time input event is from; a corresponding event type indicative of an input type of the real-time input event (e.g., keyboard activity such as key presses, mouse activity such as mouse clicks, other pointer activity, etc.); or a corresponding timestamp indicative of when the real-time input event occurred.

In some aspects, during the duration of the online examination (or other similar session), the monitoring module 134 is configured to log (i.e., record) each real-time screen event received, resulting in a logged screen event. In one aspect, one or more logged screen events include, but are not limited to, a change in focus of a person visible in the video data stream(s) during the online examination from one UI element/region of current on-screen content to another UI element/region (e.g., which UI element/region of the current on-screen content is highlighted or a pointer is positioned over), a transition from one page of the current on-screen content to another page (i.e., page transition), etc.

In some aspects, the monitoring module 134 performs an analysis for each group of logged real-time input events. In one aspect, a group of logged real-time input events comprises consecutive logged real-time input events occurring within a pre-defined short time interval during the online examination (e.g., all key presses within a short interval). In another aspect, a group of logged real-time input events comprises all logged real-time input events associated with a particular interactable UI element of on-screen content presented during the online examination (e.g., clicking a particular button). Specifically, as part of the analysis for each group of logged real-time input events, the module 134 is configured to: (1) determine a corresponding time interval during which the logged real-time input events occur, (2) extract or select one or more corresponding video frames from the video data stream(s), where the one or more corresponding video frames are within a time window occurring before the corresponding time interval (i.e., pre-event window), (3) extract or select one or more additional corresponding video frames from the video data stream(s), where the one or more additional corresponding video frames are within a time window occurring around or spanning the corresponding time interval (i.e., post-event window), (4) utilize at least one machine learning model 140 to detect at least one corresponding physical movement (i.e., motion) of at least one body region (e.g., shoulders, arms, hands, head, etc.) of a person visible in the video data stream(s) during the online examination, based on each corresponding video frame extracted or selected, and (5) optionally, utilize at least one machine learning model 140 to determine a corresponding eye gaze direction of the person and a corresponding screen region on the display 104 that the eye gaze direction is towards, based on each corresponding video frame extracted or selected.

In some aspects, as part of the analysis for each group of logged real-time input events, the monitoring module 134 is configured to compute one or more corresponding instantaneous correlation metrics, based on at least one of the following: a corresponding physical movement (i.e., motion) of a body region of a person visible in the video data stream(s) during the online examination; or a corresponding eye gaze direction of the person and a corresponding screen region on the display 104 that the eye gaze direction is towards. In some aspects, the one or more corresponding instantaneous correlation metrics include, but are not limited to, at least one the following: a motion-correlation metric indicative of whether a motion magnitude of the corresponding physical movement exceeds a pre-defined minimal motion threshold within a predefined time window occurring around or spanning a time interval during which the logged real-time input events occur; or, if the logged real-time input events are associated with an active UI element/region of current on-screen content, a gaze-correlation metric indicative of whether the corresponding eye gaze direction is directed to a screen region on the display 104 associated with the UI element/region at times during which the logged real-time input events occur.

In some aspects, the monitoring module 134 is configured to compute one or more exam-session behavioral features specific to the online examination (or other similar session), where the one or more exam-session behavioral features represent or summarize current behavior of a person visible in the video data stream(s) during the online examination. Examples of exam-session behavioral features include, but are not limited to, input-dynamics features corresponding to groups of real-time logged input events, or distributions of motion-correlation metrics and/or gaze-correlation metrics across the groups of real-time logged input events. In some aspects, exam-session behavioral features are computed over pre-defined monitoring intervals (e.g., computed every few seconds or minutes).

In some aspects, the monitoring module 134 is configured to provide to one or more others modules of the user presence verification system 120 at least one of the following outputs: a time series of one or more per-group correlation metrics corresponding to one or more groups of logged real-time input events; or one or more exam-session behavioral features (e.g., exam-session behavioral feature vectors) specific to the online examination. A per-group correlation metrics comprises one or more instantaneous correlation metrics corresponding to a particular group of logged real-time input events.

In some aspects, the user presence verification system 120 includes a proxy detection module 136 configured to receive at least one of the following inputs: a time series of one or more per-group correlation metrics corresponding to one or more groups of logged real-time input events (e.g., from monitoring module 134); one or more exam-session behavioral features (e.g., exam-session behavioral feature vectors) specific to an online examination (or other similar session) (e.g., from monitoring module 134); a behavioral digital fingerprint profile corresponding to the user 112 enrolled in the online examination (e.g., from behavioral digital fingerprint creation module 132 or behavioral digital fingerprint database 152); or one or more pre-defined thresholds.

In some aspects, the proxy detection module 136 is configured to verify whether the user 112 is participating in and/or attending to the online examination (i.e., taking the online examination). In some aspects, as part of the verifying, the proxy detection module 136 performs a consistency check for each group of logged real-time input events (i.e., per-group operator consistency check). Specifically, as part of the consistency check for each group of logged real-time input events, the proxy detection module 136 is configured to determine at least one of the following: (1) whether a corresponding motion-correlation metric value (included in a corresponding per-group correlation metrics) is below a pre-defined motion threshold, or (2) whether a corresponding gaze-correlation metric (included in the corresponding per-group correlation metrics) is below a pre-defined gaze threshold. If the corresponding motion-correlation metric value is below the pre-defined motion threshold or the corresponding gaze-correlation metric is below the pre-defined gaze threshold, the proxy detection module 136 is configured to flag or mark the group of logged real-time input events as inconsistent (i.e., inconsistent group of logged real-time input events). An inconsistent group of logged real-time input events signifies that a person visible in video data stream(s) captured by the camera 106 and/or the camera 172 during the online examination (or other similar session) does not exhibit at least one of a visible physical movement (i.e., motion) or an eye gaze direction compatible with the logged real-time input events.

In some aspects, as part of the verifying, the proxy detection module 136 is configured to compute, over a sliding time window, a corresponding local inconsistency ratio, where the local inconsistency ratio indicates a number or fraction of inconsistent groups of logged real-time input events relative to all groups of logged real-time input events occurring during the sliding time window.

In some aspects, as part of the verifying, the proxy detection module 136 performs a fingerprint similarity check. As part of the fingerprint similarity check, the proxy detection module 136 is configured to derive a current behavioral feature vector from the one or more exam-session behavioral features received, perform a comparison between the current behavioral feature vector and the behavioral digital fingerprint profile corresponding to the user 112, and generate a similarity check result based on the comparison. In one aspect, the comparison includes computing a distance between the current behavioral feature vector and a feature vector derived from the behavioral digital fingerprint profile. In another aspect, the comparison includes utilizing a machine learning model 140 trained to receive, as inputs, the current behavioral feature vector and the behavioral digital fingerprint profile, and generate, as output, a similarity score representing a probability (i.e., degree of likelihood) a person visible in video data stream(s) captured by the camera 106 and/or the camera 172 during the online examination is the same person who operated the same input device group utilized during enrollment (i.e., same input device(s) 114 utilized by the user 112 during the enrollment) and is attending to/interacting with on-screen content presented on the display 104 during the online examination. If the computed distance or the similarity score falls below a pre-defined similarity threshold, the similarity check result indicates that the comparison was a failure (i.e., failed similarity check result). If the computed distance or the similarity score meets or exceeds the pre-defined similarity threshold, the similarity check result indicates that the comparison was a success (i.e., successful similarity check result).

In some aspects, as part of the verifying, the proxy detection module 136 is configured to combine, utilizing a machine learning model 140 or a combination of one or more rules, one or more local inconsistency ratios and one or more similarity check results into a cheating score (or in the alternative, a trust score) corresponding to the online session. The cheating score indicates whether the online session is potentially suspicious (e.g., whether there is a potential cheating attempt). In some aspects, the proxy detection module 136 is configured to compare the cheating score (or in the alternative, the trust score) against one or more pre-defined thresholds. In some aspects, the proxy detection module 136 is configured to store the cheating score (or in the alternative, the trust score) in a database 154 (e.g., score database).

In some aspects, if the cheating score exceeds a first pre-defined cheating score threshold (or in the alternative, the trust score falls below a first pre-defined trust score threshold), the proxy detection module 136 triggers one or more additional verification actions. Examples of an additional verification action include, but are not limited to, presenting a challenge on the display 104, initiating a reflection-based liveness check, and notifying a human proctor (e.g., generating and transmitting an optional alert to the human proctor).

In some aspects, if the cheating score exceeds a second pre-defined cheating score threshold that is higher than the first pre-defined cheating score threshold, the proxy detection module 136 is configured to generate an incident record indicative of a likely cheating attempt during the online examination, and perform at least one of the following actions: pause, terminate, or invalidate the online session (e.g., pause, terminate, or invalidate the online examination); store one or more detailed logs for later review; or immediately notify an examiner (e.g., generating and transmitting an optional alert to the examiner). In some aspects, a likely cheating attempt comprises proxy test-taking in which a proxy is operating the same input device group utilized during enrollment (i.e., same input device(s) 114 utilized by the user 112 during the enrollment) and/or attending to/interacting with on-screen content during the online examination (i.e., the proxy is different from the user 112 who enrolled for the online examination).

In some aspects, the proxy detection module 136 is configured to provide at least one of the following outputs: one or more discrete incident records indicating one or more likely cheating attempts (e.g., likely proxy test-taking) during the online examination; or a continuous state/status of the online session.

In some aspects, the proxy detection module 136 is configured to estimate a confidence score associated with verifying whether the user 112 is participating in and/or attending to the online examination (i.e., taking the online examination). In one aspect, the confidence score represents a degree of statistical certainty that the cheating score (or in the alternative, the trust score) corresponding to the online session is correct. In some aspects, the confidence score is estimated based on one or more conditions, where the one or more conditions include at least one of amount of lighting in video data stream(s) captured by the camera 106 and/or the camera 172 during the online examination, amount of contrast in the video data stream(s), amount of body occlusion in the video data stream(s), or video quality of the video data stream(s).

In some aspects, the proxy detection module 136 is configured to verify whether the user 112 is participating in and/or attending to the online examination (i.e., taking the online examination) by determining whether there is a correlation between the logged real-time input events and at least one of a physical movement or an eye gaze direction detected in video data stream(s) captured by the camera 106 and/or the camera 172 during the online examination.

In some aspects, the proxy detection module 136 is configured to verify whether the user 112 is participating in and/or attending to the online examination (i.e., taking the online examination) by identifying the user 112 based on one or more patterns linking the logged real-time input events to at least one of a physical movement or an eye gaze direction detected in video data stream(s) captured by the camera 106 and/or the camera 172 during the online examination.

In some aspects, the user presence verification system 120 optionally includes a training module 138 and a training database 156 including one or more sets of training data. The training module 138 is configured to train or update (e.g., finetune) at least one machine learning model 140 based on at least one set of training data from the training database 156.

In some aspects, the user presence verification system 120 is configured to run on a standard end user device or consumer device, such as the computing device 102. In some aspects, the user presence verification system 120 is compatible with both web-based and native application environments. In some aspects, the user presence verification system 120 requires no specialized hardware components or resources, and can utilize standard hardware resources (e.g., a central processing unit (CPU), a graphical processing unit (GPU), and/or a memory) already available in standard end user devices or consumer devices. In some aspects, the user presence verification system 120 can be deployed on cloud servers for enterprise-scale application scenarios.

In some aspects, the user presence verification system 120 is integrated into, or implemented as part of, educational and training platforms.

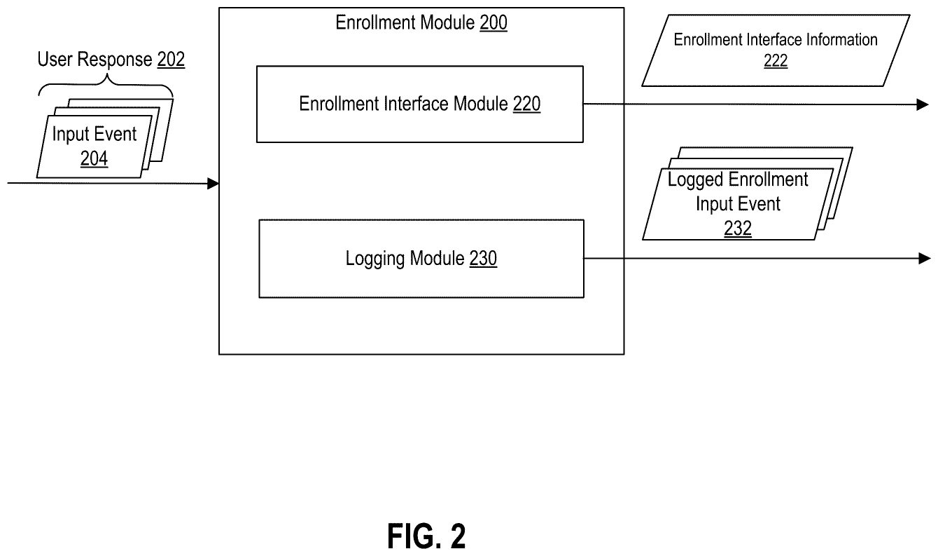

FIG. 2 is a block diagram of an example enrollment module 200, according to some aspects of the present disclosure. In some aspects, the enrollment module 130 in FIG. 1 is implemented as the enrollment module 200.

In some aspects, the enrollment module 200 includes an enrollment interface module 220 configured to initiate an enrollment during which a user (e.g., user 112 in FIG. 1) is enrolled for an online examination (or other similar session) to be administered and/or proctored by the user presence verification system 120 (FIG. 1) at a later time (e.g., after the enrollment). In some aspects, the enrollment interface module 220 initiates the enrollment by invoking the display module 122 (FIG. 1) to present a GUI representing an enrollment interface on the display 104 (FIG. 1).

In some aspects, as part of the enrollment, the enrollment interface module 220 is configured to present an instruction to the user, where the instruction prompts the user to perform one or more pre-defined tasks. In some aspects, the enrollment interface and the instruction are presented simultaneously. In one aspect, the enrollment interface module 220 invokes the display module 122 (FIG. 1) to present the instruction on the display 104 (FIG. 1) (e.g., as part of the enrollment interface). In another aspect, the enrollment interface module 220 invokes another module (not shown) of the user presence verification system 120 (FIG. 1) to activate/trigger audio playback of the instruction, i.e., the instruction is presented via one or more audio speakers (not shown).

In some aspects, the enrollment module 200 is configured to receive, as input, one or more input events 204 from an input device group during the enrollment, where the input device group comprises at least one input device 114 (FIG. 1) utilized by the user during the enrollment. The one or more input events 204 received represent a user response 202 from the user to the instruction presented.

In some aspects, the enrollment module 200 includes a logging module 230 configured to log (i.e., record) each input event 204 received during the enrollment with corresponding input event information, resulting in a logged enrollment input event 232. A logged enrollment input event 232 includes an input event 204 received and at least one of the following corresponding input event information: a corresponding device identifier indicative of a particular input device 114 (FIG. 1) the input event 204 is from, a corresponding event type indicative of an input type of the input event 204 (e.g., keyboard activity such as key presses, mouse activity such as mouse clicks, etc.), or a corresponding timestamp indicative of when the input event 204 occurred.

In some aspects, the enrollment module 200 is configured to provide to one or more others modules of the user presence verification system 120 (FIG. 1) at least one of the following outputs: one or more logged enrollment input events 232 (e.g., from logging module 230); or enrollment interface information 222 (e.g., from enrollment interface module 220) corresponding to the enrollment interface presented to the user during the enrollment. In some aspects, the enrollment interface information 222 indicates, for each user interface (UI) element (e.g., button, text area, etc.) of the enrollment interface, a corresponding screen position/region on the display 104 (FIG. 1) that the UI element is positioned at, and a corresponding identification for the UI element.

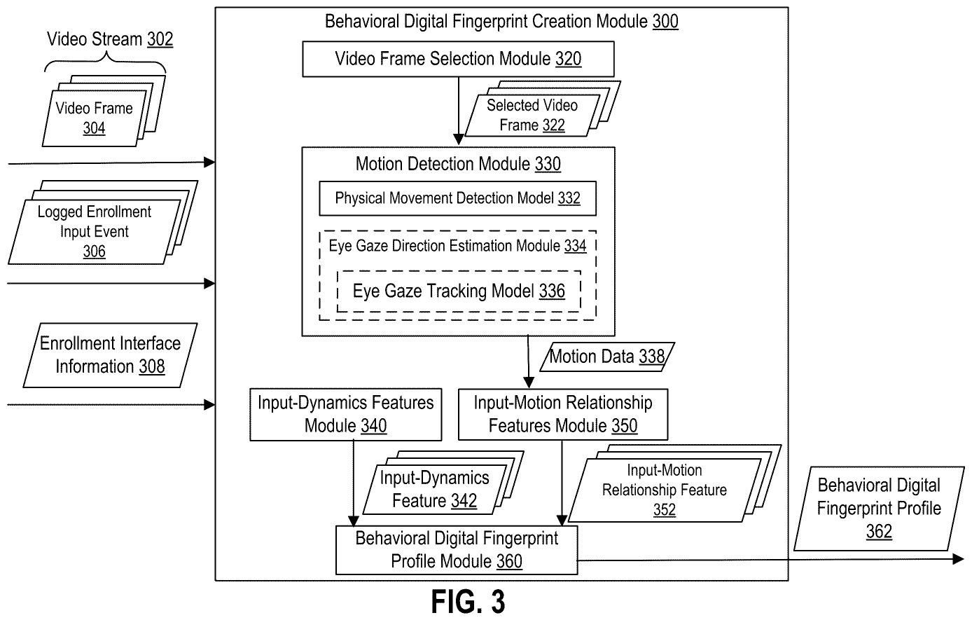

FIG. 3 is a block diagram of an example behavioral digital fingerprint creation module 300 according to some aspects of the present disclosure. In some aspects, the behavioral digital fingerprint creation module 132 in FIG. 1 is implemented as the behavioral digital fingerprint creation module 300.

In some aspects, the behavioral digital fingerprint creation module 300 is configured to receive at least one of the following inputs: video data stream(s) 302 comprising one or more video frames 304 captured by the camera 106 (FIG. 1) and/or the camera 172 (FIG. 1) during an online session (e.g., from camera module 124 in FIG. 1); one or more logged enrollment input events 306 (e.g., from enrollment module 130 in FIG. 1 or enrollment module 200 in FIG. 2); or enrollment interface information 308 corresponding to an enrollment interface presented to a user (e.g., user 112 in FIG. 1) during enrollment (e.g., from enrollment module 130 in FIG. 1 or enrollment module 200 in FIG. 2).

In some aspects, the behavioral digital fingerprint creation module 300 includes a video frame selection module 320. For each logged enrollment input event 306 or each group of logged enrollment input events 306, the video frame selection module 320 is configured to: (1) determine a corresponding time interval during which the logged enrollment input event(s) 306 occur, (2) extract or select one or more corresponding video frames 322 from the video data stream(s) 302, where the one or more corresponding video frames 322 are within a time window occurring before the corresponding time interval (i.e., pre-event window), and (3) extract or select one or more additional corresponding video frames 322 from the video data stream(s) 302, where the one or more additional corresponding video frames 322 are within a time window occurring around or spanning the corresponding time interval (i.e., post-event window).

In some aspects, the behavioral digital fingerprint creation module 300 includes a motion detection module 330. For each logged enrollment input event 306 or each group of logged enrollment input events 306, the motion detection module 330 is configured to utilize a physical movement detection model 332 to detect at least one corresponding physical movement (i.e., motion) of at least one body region (e.g., shoulders, arms, hands, head, etc.) of the user during the enrollment, based on each corresponding video frame 322 extracted or selected. The motion detection module 330 optionally includes an eye gaze direction estimation module 334 configured to utilize an optional eye gaze tracking model 336 to determine a corresponding eye gaze direction of the user during the enrollment and a corresponding screen region on the display 104 (FIG. 1) that the eye gaze direction is towards, based on each corresponding video frame 322 extracted or selected. In some aspects, the motion detection module 330 is configured to provide motion data 338 indicative of at least one of a physical movement or an eye gaze direction of the user during the enrollment.

In some aspects, each model 332, 336 is a machine learning model.

In some aspects, the behavioral digital fingerprint creation module 300 includes an input-dynamics features module 340 configured to determine one or more input-dynamics features 342 corresponding to one or more logged enrollment input events 306. For example, if the one or more logged enrollment input events 306 comprise keyboard activity such as key presses, the input-dynamics features module 340 is configured to determine at least one of the following corresponding input-dynamics features 342: one or more hold times, where each hold time indicates an amount of time a particular key is held/pressed; one or more inter-key intervals, where each inter-key interval indicates an amount of time between holding/pressing consecutive keys; one or more error and correction statistics (e.g., correcting mistypes); or one or more distributions of burst lengths, where each burst length indicates a length of a burst of keyboard activity.

As another example, if the one or more logged enrollment input events 306 comprise mouse activity such as mouse clicks or another type of pointer activity, the input-dynamics features module 340 is configured to determine at least one of the following corresponding input-dynamics features 342: one or more movement speeds (e.g., of mouse 110 in FIG. 1 or another pointing device); one or more acceleration patterns (e.g., of mouse 110 in FIG. 1 or another pointing device); one or more path curvatures (e.g., of mouse 110 in FIG. 1 or another pointing device); or one or more click timings (e.g., of mouse 110 in FIG. 1 or another pointing device).

In some aspects, the behavioral digital fingerprint creation module 300 includes an input-motion relationship features module 350 configured to, based on motion data 338 (e.g., from motion detection module 330), temporally and/or spatially align one or more logged enrollment input events 306 with at least one of a physical movement or an eye gaze direction of the user during the enrollment, and determine one or more input-motion relationship features 352 corresponding to the one or more logged enrollment input events 306. Examples of input-motion relationship features 352 include, but are not limited to, the following: at least one statistic of motion magnitude for a detected physical movement (i.e., motion) in a body region of the user during a temporal window surrounding at least one burst of keyboard, mouse, and/or other pointer activity; a distribution of latency between onset of a detected physical movement (i.e., motion) and onset of at least one burst of keyboard, mouse, and/or other pointer activity; or a frequency with which an eye gaze direction of the user is towards a screen region of the display 104 (FIG. 1) that is associated with an active input target (e.g., an UI element of the enrollment interface) when a logged enrollment input event 306 occurs.

In some aspects, the behavioral digital fingerprint creation module 300 includes a behavioral digital fingerprint profile module 360 configured to aggregate one or more input-dynamics features 342 and one or more input-motion relationship features 352 corresponding to one or more logged enrollment input events 306 into a behavioral digital fingerprint profile 362 corresponding to the user. The behavioral digital fingerprint profile 362 captures both dynamics of user inputs provided by the user and temporal and/or spatial correspondences between the user inputs and at least one of visible physical movements and/or an eye gaze direction of the user during the enrollment.

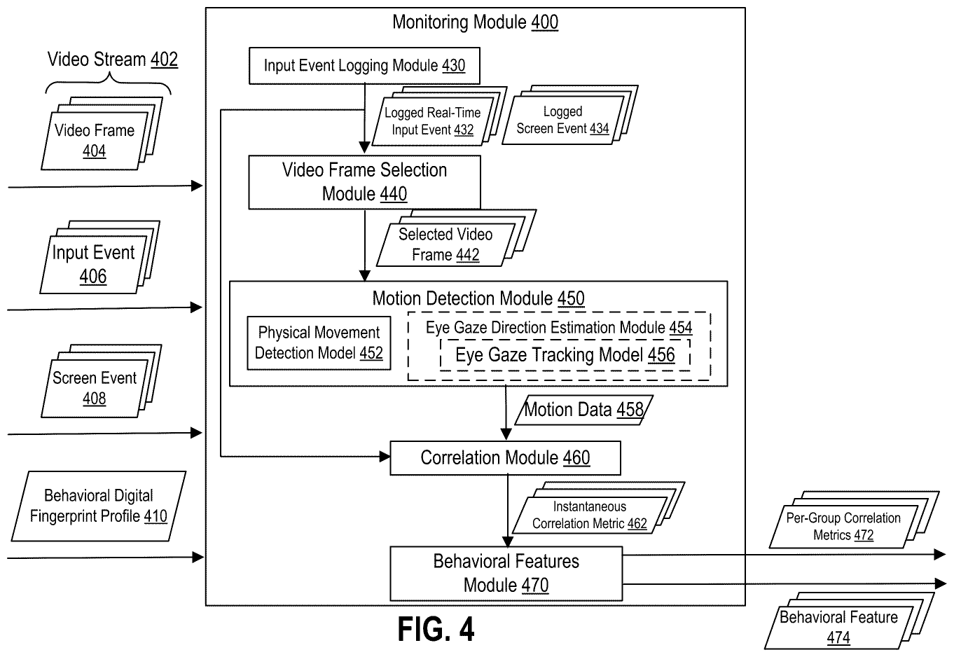

FIG. 4 is a block diagram of an example monitoring module 400, according to some aspects of the present disclosure. In some aspects, the monitoring module 134 in FIG. 1 is implemented as the monitoring module 400.

In some aspects, the monitoring module 400 is configured to receive at least one of the following inputs: a behavioral digital fingerprint profile 410 corresponding to a user (e.g., user 112 in FIG. 1) (e.g., from behavioral digital fingerprint creation module 132 in FIG. 1, behavioral digital fingerprint creation module 300 in FIG. 3, or behavioral digital fingerprint database 152); real-time video data stream(s) 402 comprising one or more video frames 404 captured by the camera 106 (FIG. 1) and/or the camera 172 (FIG. 1) during an online session (e.g., from camera module 124 in FIG. 1); one or more real-time input events 406 from the same input device group utilized during enrollment (i.e., same input device(s) 114 utilized by the user during the enrollment); or one or more real-time screen events 408 indicating which UI elements and/or regions of current on-screen content (i.e., current GUI, such as a current online examination interface if the online session comprises an online examination) presented on the display 104 (FIG. 1) are active (e.g., focused user input field, currently visible page, etc.) (e.g., from display module 122 in FIG. 1).

In some aspects, the monitoring module 400 is configured to initiate an online examination (or other similar session) after enrollment of the user.

In some aspects, the monitoring module 400 includes an input event logging module 430 configured to log (i.e., record) each real-time input event 406 received during the online examination with corresponding input event information, resulting in a logged real-time input event 432. A logged real-time input event 432 includes a real-time input event 406 received and at least one of the following corresponding input event information: a corresponding device identifier indicative of a particular input device 114 (FIG. 1) the input event 406 is from, a corresponding event type indicative of an input type of the input event 406 (e.g., keyboard activity such as key presses, mouse activity such as mouse clicks, etc.), or a corresponding timestamp indicative of when the input event 406 occurred.

In some aspects, the input event logging module 430 is configured to log (i.e., record) each real-time screen event 408, resulting in a logged screen event 434. In one aspect, one or more logged screen events 434 include, but are not limited to, a change in focus of the user from one UI element/region of current on-screen content to another UI element/region (e.g., which UI element/region of the current on-screen content is highlighted or a pointer is positioned over), a transition from one page of the current on-screen content to another page (i.e., page transition), etc.

In some aspects, the monitoring module 400 includes a video frame selection module 440. For each group of logged real-time input events 432, the video frame selection module 440 is configured to: (1) determine a corresponding time interval during which the logged real-time input events 432 occur, (2) extract or select one or more corresponding video frames 442 from the video data stream(s) 402, where the one or more corresponding video frames 442 are within a time window occurring before the corresponding time interval (i.e., pre-event window), and (3) extract or select one or more additional corresponding video frames 442 from the video data stream(s) 402, where the one or more additional corresponding video frames 442 are within a time window occurring around or spanning the corresponding time interval (i.e., post-event window).

In some aspects, the monitoring module 400 includes a motion detection module 450. For each group of logged real-time input events 432, the motion detection module 450 is configured to utilize a physical movement detection model 452 to detect at least one corresponding physical movement (i.e., motion) of at least one body region (e.g., shoulders, arms, hands, head, etc.) of the user during the online examination, based on each corresponding video frame 442 extracted or selected. The motion detection module 450 optionally includes an eye gaze direction estimation module 454 configured to utilize an optional eye gaze tracking model 456 to determine a corresponding eye gaze direction of the user during the online examination and a corresponding screen region on the display 104 (FIG. 1) that the eye gaze direction is towards, based on each corresponding video frame 442 extracted or selected. In some aspects, the motion detection module 450 is configured to provide motion data 458 indicative of at least one of a physical movement or an eye gaze direction of the user during the enrollment.

In some aspects, the monitoring module 400 includes a correlation module 460. For each group of logged real-time input events 432, the correlation module 460 is configured to compute, based on motion data 458 (e.g., from motion detection module 450), one or more corresponding instantaneous correlation metrics 462. In some aspects, the one or more corresponding instantaneous correlation metrics 462 include, but are not limited to, at least one of the following: a motion-correlation metric indicative of whether a motion magnitude of a corresponding physical movement exceeds a pre-defined minimal motion threshold within a pre-defined time window occurring around or spanning a time interval during which the logged real-time input events 432 occur; or, if the logged real-time input events 432 are associated with an active UI element/region of current on-screen content, a gaze-correlation metric indicative of whether a corresponding eye gaze direction is directed to a screen region on the display 104 (FIG. 1) associated with the UI element/region at times during which the logged real-time input events 432 occur.

In some aspects, the monitoring module 400 includes a behavioral features module 470 configured to compute one or more exam-session behavioral features 474 specific to the online examination (or other similar session), where the one or more exam-session behavioral features 474 represent or summarize current behavior of a person visible in the video during the online examination. Examples of exam-session behavioral features 474 include, but are not limited to, input-dynamics features corresponding to groups of logged real-time input events 432, or distributions of motion-correlation metrics and/or gaze-correlation metrics across the groups of logged real-time input events 432. In some aspects, exam-session behavioral features are computed over pre-defined monitoring intervals (e.g., computed every few seconds or minutes).

In some aspects, the monitoring module 400 is configured to provide at least one of the following outputs: a time series of one or more per-group correlation metrics 472 corresponding to one or more groups of logged real-time input events 432; or one or more exam-session behavioral features 474 (e.g., exam-session behavioral feature vectors) specific to the online examination. A per-group correlation metrics 472 comprises one or more instantaneous correlation metrics corresponding to a particular group of logged real-time input events 432.

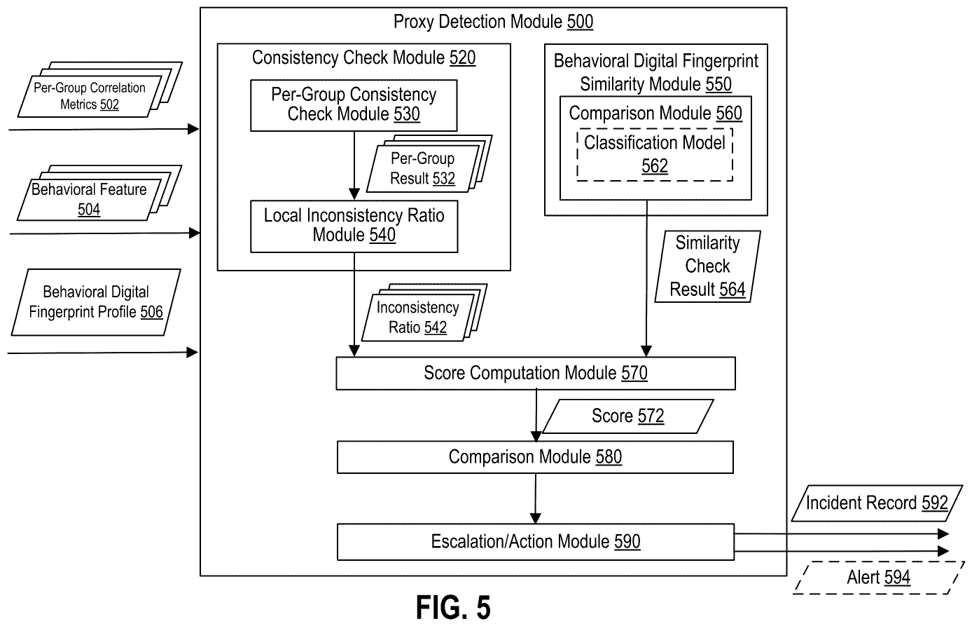

FIG. 5 is a block diagram of an example proxy detection module 500, according to some aspects of the present disclosure. In some aspects, the proxy detection module 136 in FIG. 1 is implemented as the proxy detection module 500.

In some aspects, the proxy detection module 500 is configured to receive at least one of the following inputs: a time series of one or more per-group correlation metrics 502 corresponding to one or more groups of logged real-time input events (e.g., from monitoring module 134 in FIG. 1 or monitoring module 400 in FIG. 4); one or more exam-session behavioral features 504 (e.g., exam-session behavioral feature vectors) specific to an online examination (or other similar session) (e.g., from monitoring module 134 in FIG. 1 or monitoring module 400 in FIG. 4); a behavioral digital fingerprint profile 506 corresponding to a user (e.g., user 112 in FIG. 1) enrolled in the online examination (e.g., from behavioral digital fingerprint creation module 132 in FIG. 1, behavioral digital fingerprint creation module 300 in FIG. 3, or behavioral digital fingerprint database 152 in FIG. 1); or one or more pre-defined thresholds.

In some aspects, the proxy detection module 500 includes a consistency check module 520 configured to perform a consistency check for each group of logged real-time input events (i.e., per-group operator consistency check). Specifically, as part of the consistency check for each group of logged real-time input events, the consistency check module 520 includes a per-group consistency check module 530 configured to: (1) perform at least one of a first determination of whether a corresponding motion-correlation metric value (included in a corresponding per-group correlation metrics 502) is below a pre-defined motion threshold or a second determination of whether a corresponding gaze-correlation metric (included in the corresponding per-group correlation metrics 502) is below a pre-defined gaze threshold, and (2) provide a corresponding per-group result 532 based on at least one of the first determination or the second determination. If the corresponding motion-correlation metric value is below the pre-defined motion threshold or the corresponding gaze-correlation metric is below the pre-defined gaze threshold, the proxy detection module 500 is configured to flag or mark the group of logged real-time input events as inconsistent (i.e., inconsistent group of logged real-time input events). An inconsistent group of logged real-time input events signifies that a person visible in video data stream(s) captured by the camera 106 (FIG. 1) and/or the camera 172 (FIG. 1) during the online examination (or other similar session) does not exhibit at least one of a visible physical movement (i.e., motion) or an eye gaze direction compatible with the logged real-time input events.

In some aspects, the proxy detection module 500 includes a local inconsistency ratio module 540 configured to compute, over a sliding time window, a corresponding local inconsistency ratio 542, where the local inconsistency ratio 542 indicates a number or fraction of inconsistent groups of logged real-time input events relative to all groups of logged real-time input events occurring during the sliding time window.

In some aspects, the proxy detection module 500 includes a behavioral digital fingerprint similarity module 550 configured to perform a fingerprint similarity check. As part of the fingerprint similarity check, the behavioral digital fingerprint similarity module 550 is configured to derive a current behavioral feature vector from the one or more exam-session behavioral features 504 received, perform a comparison via a comparison module 560 between the current behavioral feature vector and the behavioral digital fingerprint profile 506 corresponding to the user 112, and generate a similarity check result 564 based on the comparison. In one aspect, the comparison includes computing a distance between the current behavioral feature vector and a feature vector derived from the behavioral digital fingerprint profile 506. In another aspect, the comparison includes utilizing a classification model 562 trained to receive, as inputs, the current behavioral feature vector and the behavioral digital fingerprint profile 506, and generate, as output, a classification including a similarity score representing a probability (i.e., degree of likelihood) a person visible in the video data stream(s) during the online examination is the same person who operated the same input device group utilized during enrollment (i.e., same input device(s) 114 utilized by the user 112 during the enrollment) and is attending to/interacting with on-screen content presented on the display 104 (FIG. 1) during the online examination. If the computed distance or the similarity score falls below a pre-defined similarity threshold, the similarity check result 564 indicates that the comparison was a failure (i.e., failed similarity check result). If the computed distance or the similarity score meets or exceeds the pre-defined similarity threshold, the similarity check result 564 indicates that the comparison was a success (i.e., successful similarity check result).

In some aspects, the classification model 562 is a machine learning model.

In some aspects, the proxy detection module 500 includes a score computation module 570 configured to combine, utilizing a machine learning model (e.g., machine learning model 140 in FIG. 1) or a combination of one or more rules, one or more local inconsistency ratios and one or more similarity check results into a cheating/trust score 572 corresponding to the online session. The cheating/trust score 572 indicates whether the online session is potentially suspicious (e.g., whether there is a potential cheating attempt).

In some aspects, the proxy detection module 500 includes a comparison module 580 configured to compare the cheating/trust score 572 against one or more pre-defined thresholds.

In some aspects, if the cheating score 572 exceeds a first pre-defined cheating score threshold (or in the alternative, the trust score 572 falls below a first pre-defined trust score threshold), the proxy detection module 500 includes an escalation/action module 590 configured to trigger one or more additional verification actions.

In some aspects, if the cheating score 572 exceeds a second pre-defined cheating score threshold that is higher than the first pre-defined cheating score threshold, the escalation/action module 590 is configured to generate an incident record 592 indicative of a likely cheating attempt during the online examination, and perform at least one of the following actions: pause, terminate, or invalidate the online session (e.g., pause, terminate, or invalidate the online examination); store one or more detailed logs for later review; or immediately notify an examiner (e.g., generating and transmitting an optional alert 594 to the examiner).

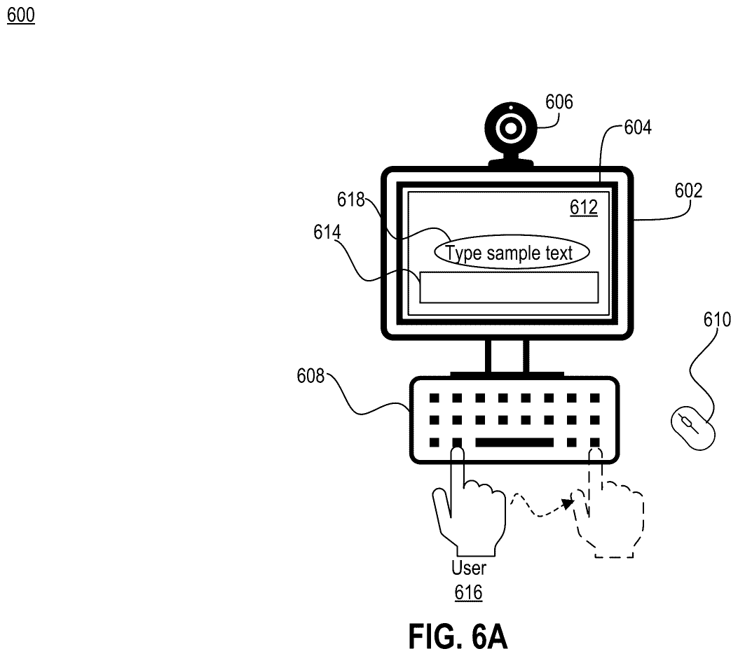

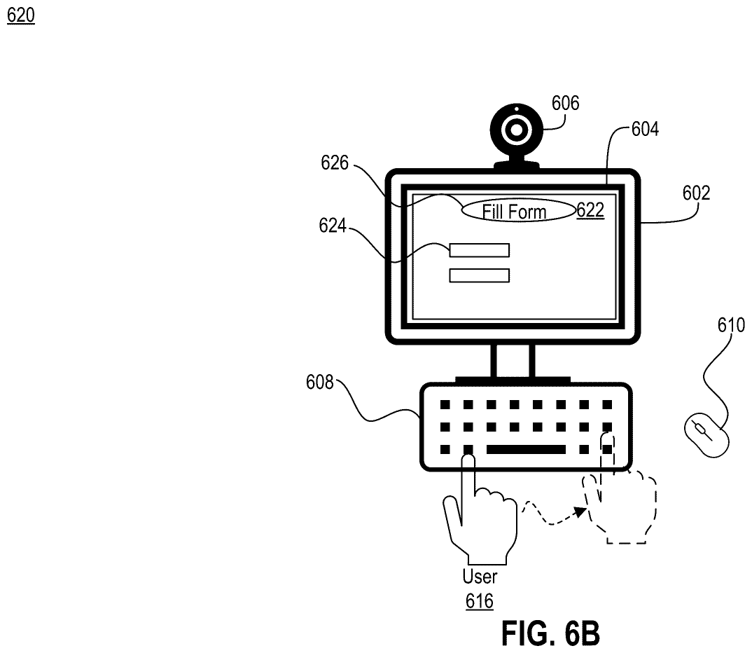

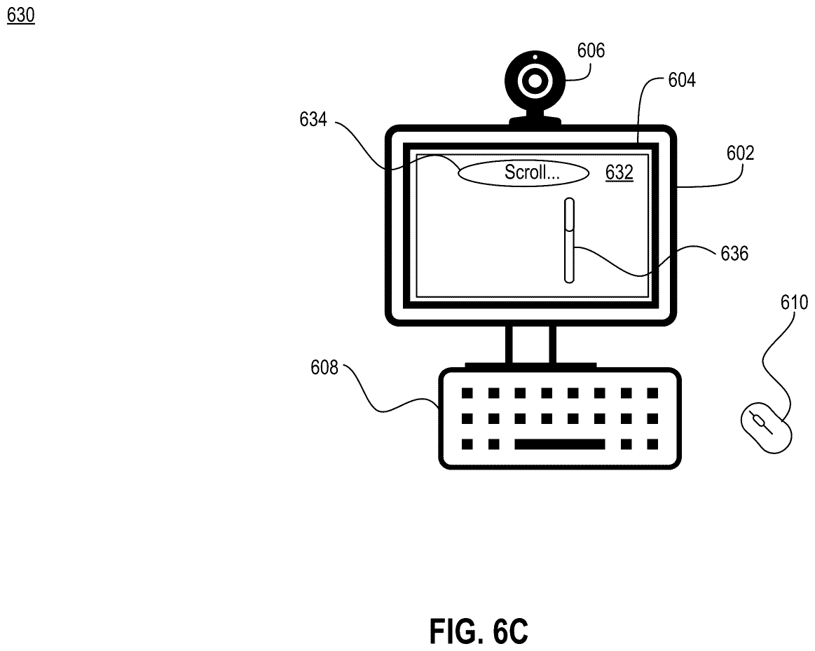

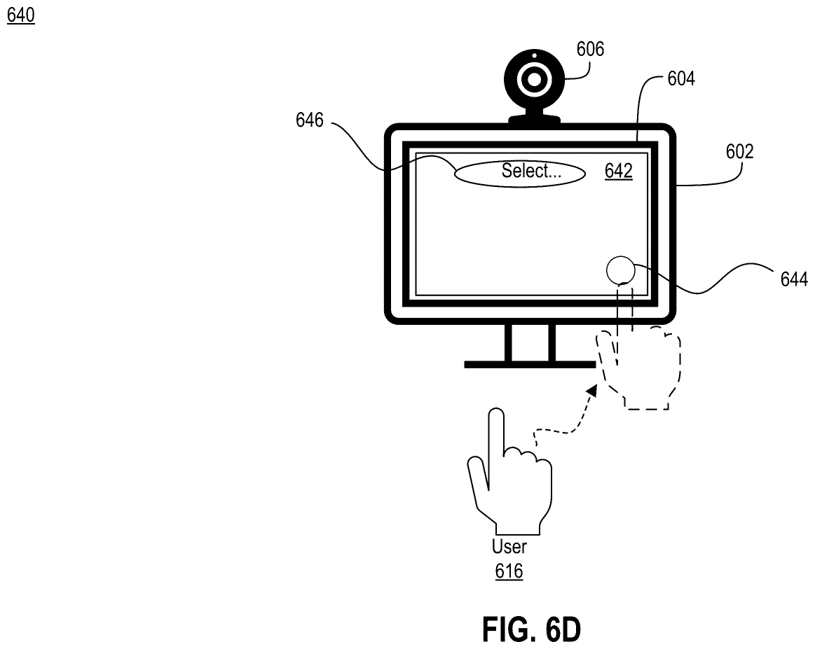

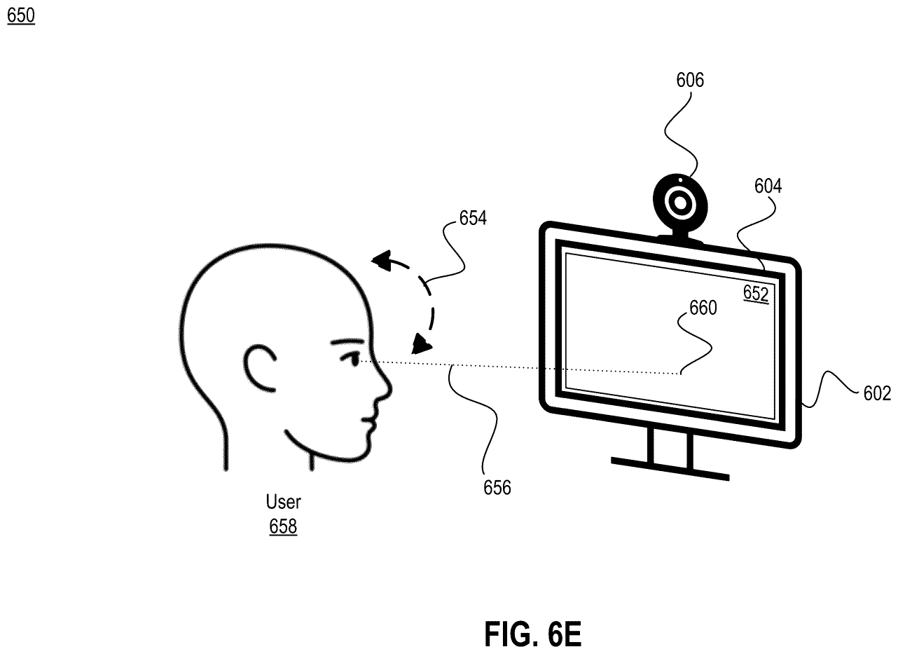

FIG. 6A is a first example pre-defined task 600 performed as part of enrollment during an online session, according to some aspects of the present disclosure. In some aspects, an initialization module 128 (FIG. 1) initializes an online session with a user 616 (e.g., user 112 in FIG. 1). In some aspects, the initialization module 128 invokes a camera module 124 (FIG. 1) which in turn activates/triggers a camera 606 coupled to, or integrated in, a computing device 602 (e.g., computing device 102 in FIG. 1) to capture a continuous video data stream during the online session. In one aspect, the camera 606 is activated/triggered after the online session is initialized.

In some aspects, an enrollment module 130 (FIG. 1) or 200 (FIG. 2) initiates the enrollment during which the user 616 is enrolled for an online examination (or other similar session) to be administered and/or proctored by a user presence verification system 120 (FIG. 1) at a later time (e.g., after the enrollment). In some aspects, the enrollment module 130/200 initiates the enrollment by invoking a display module 122 (FIG. 1) to present a first GUI representing a first enrollment interface 612 on a display 604 (e.g., display 104 in FIG. 1) coupled to, or integrated in, the computing device 602.

In some aspects, the enrollment module 130/200 presents an instruction 618 to the user 616 on the display 604 (e.g., as part of the enrollment interface 612), where the instruction 618 prompts the user 616 to perform the pre-defined task 600 of typing a sample text. The user 616 can utilize an input device group to type the sample text into a text box 614 of the enrollment interface 612, where the input device group comprises one or more input devices (e.g., input devices 114 in FIG. 1) coupled to, or integrated in, the computing device 602, such as a keyboard 608 and/or a mouse 610. In some aspects, the enrollment module 130/200 is configured to receive and log (i.e., record) each input event received from the input device group as the user 616 types on the keyboard 608 and/or clicks the mouse 610 while typing the sample text.

FIG. 6B is a second example pre-defined task 600 performed as part of enrollment during an online session, according to some aspects of the present disclosure. In some aspects, as part of the same enrollment during the same online session in FIG. 6A (or a different enrollment during a different online session), the enrollment module 130 (FIG. 1) or 200 (FIG. 2) invokes the display module 122 (FIG. 1) to present a second GUI representing a second enrollment interface 622 on the display 604.

In some aspects, the enrollment module 130/200 presents an instruction 626 to the user 616 on the display 604 (e.g., as part of the enrollment interface 622), where the instruction 626 prompts the user 616 to perform the pre-defined task 620 of filling out a digital form included in the enrollment interface 622. The user 616 can utilize an input device group to interact with one or more UI elements/regions 624 (e.g., text input fields, buttons, etc.) of the enrollment interface 622, where the input device group comprises one or more input devices (e.g., input devices 114 in FIG. 1) coupled to, or integrated in, the computing device 602, such as the keyboard 608 and/or the mouse 610. In some aspects, the enrollment module 130/200 is configured to receive and log (i.e., record) each input event received from the input device group as the user 616 types on the keyboard 608 and/or clicks the mouse 610 while filling out the digital form.

FIG. 6C is a third example pre-defined task 630 performed as part of enrollment during an online session, according to some aspects of the present disclosure. In some aspects, as part of the same enrollment during the same online session in FIG. 6A or FIG. 6B (or a different enrollment during a different online session), the enrollment module 130 (FIG. 1) or 200 (FIG. 2) invokes the display module 122 (FIG. 1) to present a third GUI representing a third enrollment interface 632 on the display 604.

In some aspects, the enrollment module 130/200 presents an instruction 634 to the user 616 on the display 604 (e.g., as part of the enrollment interface 632), where the instruction 634 prompts the user 616 to perform the pre-defined task 630 of scrolling through content included in the enrollment interface 632. The user 616 can utilize an input device group to interact with one or more UI elements/regions 636 (e.g., scroll bar, etc.) of the enrollment interface 632, where the input device group comprises one or more input devices (e.g., input devices 114 in FIG. 1) coupled to, or integrated in, the computing device 602, such as the keyboard 608 and/or the mouse 610. In some aspects, the enrollment module 130/200 is configured to receive and log (i.e., record) each input event received from the input device group as the user 616 types on the keyboard 608 and/or clicks the mouse 610 while scrolling through the content.

FIG. 6D is a fourth example pre-defined task 640 performed as part of enrollment during an online session, according to some aspects of the present disclosure. In some aspects, as part of the same enrollment during the same online session in FIG. 6A, FIG. 6B, or FIG. 6C (or a different enrollment during a different online session), the enrollment module 130 (FIG. 1) or 200 (FIG. 2) invokes the display module 122 (FIG. 1) to present a fourth GUI representing a fourth enrollment interface 642 on the display 604.

In some aspects, the enrollment module 130/200 presents an instruction 646 to the user 616 on the display 604 (e.g., as part of the enrollment interface 642), where the instruction 646 prompts the user 616 to perform the pre-defined task 640 of selecting one or more specified UI elements 644 included in the enrollment interface 642. The user 616 can utilize an input device group to interact with the one or more specified UI elements 644 (e.g., buttons, etc.) of the enrollment interface 642, where the input device group comprises one or more input devices (e.g., input devices 114 in FIG. 1) coupled to, or integrated in, the computing device 602, such as the keyboard 608 (FIG. 6A), the mouse 610 (FIG. 6A), and/or a touch screen interface of the display 604. In some aspects, the enrollment module 130/200 is configured to receive and log (i.e., record) each input event received from the input device group as the user 616 types on the keyboard 608, clicks the mouse 610, and/or touches the touch screen interface of the display 604 while selecting the one or more specified UI elements 644.

FIG. 6E is an example monitoring 650 during an online session after enrollment, according to some aspects of the present disclosure. In some aspects, during the same online session in FIG. 6A, FIG. 6B, or FIG. 6C (or during a different online session), a monitoring module 134 (FIG. 1) or 400 (FIG. 4) initiates an online examination (or other similar session) after the enrollment of the user 616 (FIG. 6A). The monitoring module 134/400 invokes the display module 122 (FIG. 1) to present a GUI including current on-screen content 652 (e.g., a current online examination interface) on the display 604.

In some aspects, the monitoring module 134/400 utilizes at least one machine learning model (e.g., machine learning model 140 in FIG. 1) to detect at least one corresponding physical movement (i.e., motion) 654 of at least one body region (e.g., shoulders, arms, hands, head, etc.) of a person 658 visible in a video data stream captured by the camera 606 during the online examination. In some aspects, the monitoring module 134/400 optionally utilizes at least one machine learning model (e.g., machine learning model 140 in FIG. 1) to determine a corresponding eye gaze direction 656 of the person 658 and a corresponding screen region 660 on the display 604 that the eye gaze direction 656 is towards. Based in part on at least one of the corresponding physical movement 654 or the corresponding eye gaze direction 656, the user presence verification system 120 (FIG. 1) determines whether the person 658 visible in the video data stream during the online examination is the same person as the user 616 (FIG. 6A-6D) who operated the same input device group utilized during the enrollment and is attending to/interacting with on-screen content presented on the display 604 during the online examination.

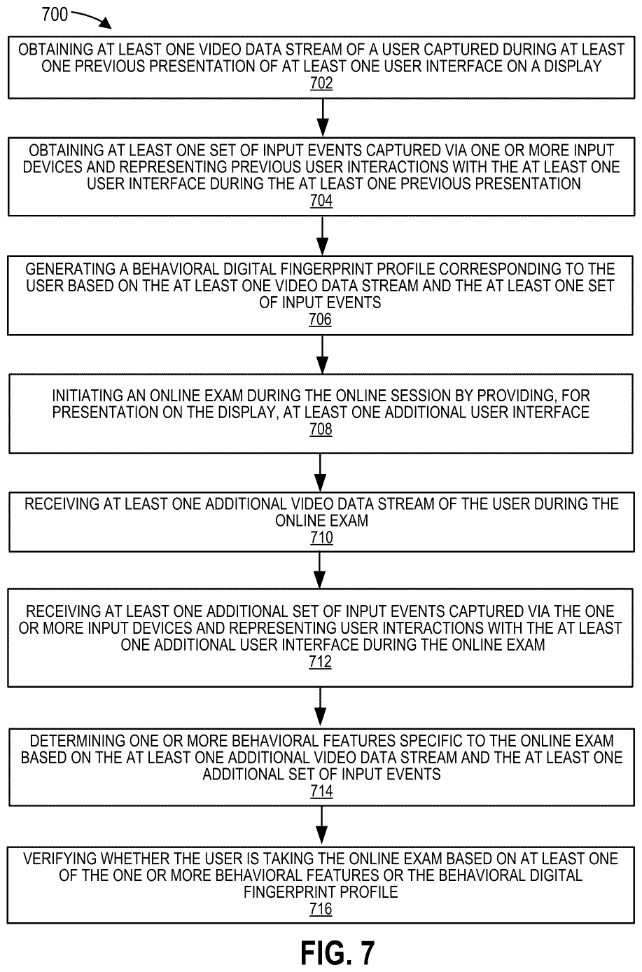

FIG. 7 is flow diagram of an example method 700 for verifying live user presence in an online session, according to some aspects of the present disclosure. At block 702, the method 700 includes obtaining at least one video data stream of a user captured during at least one previous presentation of at least one user interface on a display.

At block 704, the method 700 includes obtaining at least one set of input events captured via one or more input devices and representing previous user interactions with the at least one user interface during the at least one previous presentation.

At block 706, the method 700 includes generating a behavioral digital fingerprint profile corresponding to the user based on the at least one video data stream and the at least one set of input events.

At block 708, the method 700 includes initiating an online exam (i.e., online examination) during the online session by providing, for presentation on the display, at least one additional user interface.

At block 710, the method 700 includes receiving at least one additional video data stream of the user during the online exam.

At block 712, the method 700 includes receiving at least one additional set of input events captured via the one or more input devices and representing user interactions with the at least one additional user interface during the online exam.

At block 714, the method 700 includes determining one or more behavioral features specific to the online exam based on the at least one additional video data stream and the at least one additional set of input events.

At block 716, the method 700 includes verifying whether the user is taking the online exam based on at least one of the one or more behavioral features or the behavioral digital fingerprint profile.

In some aspects, blocks 702-716 of the method 700 can be performed by one or more components of the user presence verification system 120 (FIG. 1), the enrollment module 200 (FIG. 2), the behavioral digital fingerprint creation module 300 (FIG. 3), the monitoring module 400 (FIG. 4), and/or the proxy detection module 500 (FIG. 5).

Aspects of the present disclosures, such as the user presence verification system 120 (FIG. 1), the enrollment module 200 (FIG. 2), the behavioral digital fingerprint creation module 300 (FIG. 3), the monitoring module 400 (FIG. 4), and/or the proxy detection module 500 (FIG. 5), can be implemented using hardware, software, or a combination thereof and can be implemented in one or more computer systems or other processing systems. In an aspect of the present disclosures, features are directed toward one or more computer systems capable of carrying out the functionality described herein. An example of such a computer system 20 is shown in FIG. 8. The user presence verification system 120, the enrollment module 200, the behavioral digital fingerprint creation module 300, the monitoring module 400, and/or the proxy detection module 500 can include some or all of the components of the computer system 20.

FIG. 8 is a block diagram illustrating the computer system 20 on which aspects of systems and methods for AI-driven visual cues (e.g., markers, pointers, highlights, etc.) for contextual navigation within graphical user interfaces may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for verifying live user presence in an online session, comprising:
obtaining at least one video data stream of a user captured during at least one previous presentation of at least one user interface on a display;
obtaining at least one set of input events captured via one or more input devices and representing previous user interactions with the at least one user interface during the at least one previous presentation;
generating a behavioral digital fingerprint profile corresponding to the user based on the at least one video data stream and the at least one set of input events;
initiating an online exam during the online session by providing, for presentation on the display, at least one additional user interface;
receiving at least one additional video data stream of the user during the online exam;
receiving at least one additional set of input events captured via the one or more input devices and representing user interactions with the at least one additional user interface during the online exam;
determining one or more behavioral features specific to the online exam based on the at least one additional video data stream and the at least one additional set of input events; and
verifying whether the user is taking the online exam based on at least one of the one or more behavioral features or the behavioral digital fingerprint profile.

2. The method of claim 1, wherein the at least one previous presentation occurred prior to the online exam, and the at least one previous presentation comprises at least one of an enrollment, a previous online exam different from the online exam during the online session, or a previous online session different from the online session.

3. The method of claim 1, further comprising:
storing the behavioral digital fingerprint profile, wherein the stored behavioral digital fingerprint profile is mapped to an identifier corresponding to the user.

4. The method of claim 1, wherein each input event has a corresponding timestamp.

5. The method of claim 4, further comprising:
detecting, based on one or more video frames of the at least one video data stream, at least one body region of the user corresponding to a physical action of the user; and
tracking a movement of the at least one body region during the at least one previous presentation;
wherein the behavioral digital fingerprint profile characterizes timing of the at least one set of input events and at least one of spatial correspondences or temporal alignments between the at least one set of input events and the tracked movement of the at least one body region.

6. The method of claim 5, wherein the one or more input devices comprise at least one of a keyboard or a mouse, and the timing of the at least one set of input events comprises at least one a key hold time of a key of the keyboard, an inter-key interval between two or more keys of the keyboard, a distribution of burst lengths of consecutive key presses of the two or more keys, one or more timings of one or more mouse clicks, or a rate of error corrections.

7. The method of claim 5, further comprising:
estimating, based on the one or more video frames of the at least one video data stream, a gaze direction of the user during the at least one previous presentation and a region of the display the gaze direction is directed to;
wherein the behavioral digital fingerprint profile further characterizes at least one of spatial correspondences or temporal alignments between the at least one set of input events and at least one of the gaze direction or the region of the display.

8. The method of claim 4, wherein the determining the one or more behavioral features comprises:
detecting, based on one or more video frames of the at least one additional video data stream, at least one body region of the user corresponding to a physical action of the user;
tracking a movement of the at least one body region during the online exam;
for each subset of the at least one additional set of input events, determining one or more corresponding correlation measurements indicative of at least one of spatial correspondences or temporal alignments between the subset and the tracked movement of the at least one body region.

9. The method of claim 8, wherein the determining the one or more behavioral features further comprises:
estimating, based on the one or more video frames of the at least one additional video data stream, a gaze direction of the user during the online exam and a region of the display the gaze direction is directed to; and
for each subset of the at least one additional set of input events, determining one or more corresponding correlation measurements indicative of at least one of spatial correspondences or temporal alignments between the subset and at least one of the gaze direction or the region of the display.

10. The method of claim 9, wherein the verifying whether the user is taking the online exam comprises:
determining a similarity measurement indicative of a degree of similarity between the one or more behavioral features and the behavioral digital fingerprint profile;
verifying the user is taking the online exam in response to determining the similarity measurement does not exceed a pre-defined similarity threshold and, for each subset of the at least one additional set of input events, one or more corresponding correlation measurements does not exceed a corresponding pre-defined correlation threshold; and
verifying the user is not taking the online exam in response to determining the similarity measurement exceeds the pre-defined similarity threshold or for at least one subset of the at least one additional set of input events, one or more corresponding correlation measurements exceeds a corresponding pre-defined correlation threshold.

11. The method of claim 9, further comprising:
triggering at least one action in response to verifying the user is not taking the online exam, wherein the at least one action comprises at least one of pausing the online exam, terminating the online exam, transmitting an alert to a proctor, or recording there is no spatial correspondence or temporal alignment between a subset of the at least one additional set of input events and at least one of the tracked movement of the at least one body region, the gaze direction, or the region of display.

12. The method of claim 1, wherein the at least one video data stream and the at least one additional video data stream are captured via at least one camera.

13. The method of claim 1, further comprising:
estimating a confidence score associated with the verifying based on one or more conditions, wherein the one or more conditions include at least one of amount of lighting in the at least one additional video data stream, amount of contrast in the at least one additional video data stream, amount of body occlusion in the at least one additional video data stream, or video quality of the at least one additional video data stream.

14. The method of claim 1, wherein the verifying whether the user is taking the online exam comprises:
determining whether there is a correlation between the at least one additional set of input events and at least one of a physical movement or an eye gaze direction detected in the at least one additional video data stream.

15. The method of claim 1, wherein the verifying whether the user is taking the online exam comprises:
identifying the user based on one or more patterns linking the at least one additional set of input events to at least one of a physical movement or an eye gaze direction detected in the at least one additional video data stream.

16. A system for verifying live user presence in an online session, comprising:
one or more memories configured to store executable instructions; and
one or more processors communicatively coupled with the one or more memories and configured, individually or in any combination, to execute the executable instructions to:
obtain at least one video data stream of a user captured during at least one previous presentation of at least one user interface on a display;
obtain at least one set of input events captured via one or more input devices and representing previous user interactions with the at least one user interface during the at least one previous presentation;
generate a behavioral digital fingerprint profile corresponding to the user based on the at least one video data stream and the at least one set of input events;
initiate an online exam during the online session by providing, for presentation on the display, at least one additional user interface;
receive at least one additional video data stream of the user during the exam;
receive at least one additional set of input events captured via the one or more input devices and representing user interactions with the at least one additional user interface during the online exam;
determine one or more behavioral features specific to the online exam based on the at least one additional video data stream and the at least one additional set of input events; and
verify whether the user is taking the online exam based on at least one of the one or more behavioral features or the behavioral digital fingerprint profile.

17. The system of claim 16, wherein the at least one previous presentation occurred prior to the online exam, and the at least one previous presentation comprises at least one of an enrollment, a previous online exam different from the online exam during the online session, or a previous online session different from the online session.

18. The system of claim 16, wherein the one or more processors are configured, individually or in any combination, to further execute the executable instructions to:
store the behavioral digital fingerprint profile, wherein the stored behavioral digital fingerprint profile is mapped to an identifier corresponding to the user.

19. The system of claim 16, wherein each input event has a corresponding timestamp.

20. A non-transitory computer-readable medium having instructions for verifying live user presence in an online session, the instructions are executable by one or more processors, individually or in any combination, to:
obtain at least one video data stream of a user captured during at least one previous presentation of at least one user interface on a display;
obtain at least one set of input events captured via one or more input devices and representing previous user interactions with the at least one user interface during the at least one previous presentation;
generate a behavioral digital fingerprint profile corresponding to the user based on the at least one video data stream and the at least one set of input events;
initiate an online exam during the online session by providing, for presentation on the display, at least one additional user interface;
receive at least one additional video data stream of the user during the online exam;
receive at least one additional set of input events captured via the one or more input devices and representing user interactions with the at least one additional user interface during the online exam;
determine one or more behavioral features specific to the online exam based on the at least one additional video data stream and the at least one additional set of input events; and
verify whether the user is taking the online exam based on at least one of the one or more behavioral features or the behavioral digital fingerprint profile.
